(19) United States
(12) Patent Application Publication
(10) Pub. No.: US 2005/0259509 A1
(43) Pub. Date: Nov. 24, 2005

(54) Kinetic shear mixer and method

(76) Inventor: Joe Franklin Arnold, Palm Beach Gardens, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/997,884

(22) Filed: Nov. 29, 2004

Related U.S. Application Data
(60) Provisional application No. 60/572,613, filed on May 20, 2004.

(51) Int. Cl. B01F 13/06

(52) U.S. Cl. 366/139

(57) ABSTRACT

A kinetic shear mixer and method. In an embodiment, a kinetic shear mixer includes a first member having a first inner chamber portion and a second member having a second inner chamber portion. When coupled to one another, the first and second inner chamber portions form a substantially closed chamber. A shearing member is coupled to the first and/or second members. The shearing member is located within an area of the closed chamber through which material being mixed travels during movement of the mixer in a mixing operation. A vacuum can be applied through a port to the closed chamber during movement of the mixer in a mixing operation. Shearing members may be retractable. A moveable piston can also be provided. The mixed material may be directly injected by application of a pressure to the opposite side of the piston or to a separate injector piston.

This application claims the benefit of U.S. Provisional Appl. No. 60/572,613, filed May 20, 2004 (incorporated in its entirety herein by reference).

### BACKGROUND OF THE INVENTION

1. Field of the Invention

The present invention related to mixing materials.

2. Background Art

Mixing materials has long been important in many manufacturing applications. Different types of mixers are available. Shaker-type mixer mills mix materials by rapidly moving a small container in a reversing arc. See, e.g., an 8000 Series Mixer-Mill available from SPEX CertiPrep, Inc. headquartered in New Jersey. Materials to be mixed are placed in the container. The container is closed during mixing. During motion of the container, the material moves back and forth within the container. Balls may be added to assist with the mixing. Gases, however, cannot be removed from the closed container during active mixing.

Shear mixing is a different type of conventional mixing approach. Conventional shear mixers use a stationary container with rotating paddles. The rotating paddles produce a shear which can dislodge air or gas and replace it with a liquid during mixing. This can help remove air bubbles. A vacuum is added to the stationary container to remove dislodged air.

Limitations exist, however, with conventional mixers. For instance, mixing fine powders and small amounts of liquid is especially difficult.

### BRIEF SUMMARY OF THE INVENTION

The present invention provides a new type of mixer and method—vacuum/kinetic shear mixing. In an embodiment, a kinetic shear mixer includes a first member having a first inner chamber portion and a second member having a second inner chamber portion. The second member can be removably coupled to the first member. When coupled to one another, the first and second inner chamber portions form a substantially closed chamber. A shearing member is coupled to the first and/or second members. The shearing member is located within an area of the closed chamber through which material being mixed travels during movement of the mixer in a mixing operation. For instance, when the mixer is moved back and forth along an arcuate path, the shearing members are located on a top area so that the material being mixed contacts each shearing member. This contact generates shearing forces within the material that facilitates faster, more complete mixing, and liberates entrained gases.

According to a feature, one or more ports are coupled to the first and/or second members. These ports can be used to insert and remove liquid mixing materials to and from the closed chamber. A vacuum can also be applied through a port to the closed chamber during movement of the mixer in a mixing operation. The vacuum allows air or gases exposed during mixing of materials to be removed further facilitating faster, more complete mixing, and results in a substantially gas-free liquid/solid mixture. This is especially advantageous when mixing fine powders with relatively little liquid as in the formation of a polymer ceramic slip. In one example not intended to limit the invention, a port is coupled to at least one of the first and second members at a side location of the closed chamber below the area through which the material being mixed travels during movement of the mixer in a mixing operation. A vacuum low enough to remove all entrained gas during the available mixing time, but high enough to not vaporize any liquid components, is required.

In another embodiment, retractable shearing members are used that can be retractably extended within the closed chamber. A piston can be moved between a retained position and a released position within the closed chamber. Each retractable shearing member can be extended within the closed chamber when the piston is in the retained position during a mixing operation, and retracted from the closed chamber when the piston is in the released position to discharge mixed material from the closed chamber after the mixing operation. This allows the vacuum mixed material to be ejected from the mixing chamber without exposure to air or other gaseous materials.

A method for mixing material is also provided. In an embodiment, a method includes the steps of: inserting material to be mixed into a chamber having a shearing member; shaking the chamber back and forth along a path such that material repeatedly contacts the shearing member during shaking; and applying a vacuum to the material in the chamber during the shaking.

According to a further feature, the method includes prior to shaking, the steps of moving a piston within the closed chamber to a retained position, and extending each shearing member within the closed chamber when the piston is in the retained position. After shaking, the method can also include the steps of retracting each shearing member from the closed chamber, releasing the piston, and moving the piston against the liquid/solid mixture volume.

One advantage is that fine powders can be mixed with a small amount of liquid rapidly and efficiently in kinetic shear vacuum mixer and method embodiments of the present invention.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

The invention is described with reference to the accompanying drawings. In the drawings, like reference numbers indicate identical or functionally similar elements. The drawing in which an element first appears is indicated by the left-most digit in the corresponding reference number.

FIG. 1A is a diagram of a kinetic shear vacuum mixer according to an embodiment of the present invention.

FIG. 1B is a cross-sectional side diagrammatic view of the kinetic shear vacuum mixer of FIG. 1A according to an embodiment of the present invention.

FIG. 2 is a cross-sectional diagrammatic view of a kinetic shear vacuum mixer with shearing members according to an embodiment of the present invention.

FIGS. 3A-3E show different views of an example connecting mechanism for two sides of the kinetic shear vacuum mixer of FIG. 1A according to an embodiment of the present invention.

FIGS. 4A-4E show different sections and views of chambers of the kinetic shear vacuum mixer of FIG. 1A with shearing members and injectors according to an embodiment of the present invention.

FIGS. 5A-5D show different sections and views of chambers of the kinetic shear vacuum mixer of FIG. 1A with retractable shearing members and injectors and a moveable piston according to a further embodiment of the present invention.

FIG. 6 shows an external piston attached to a kinetic shear vacuum mixer according to an embodiment of the present invention.

### DETAILED DESCRIPTION OF EMBODIMENTS OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

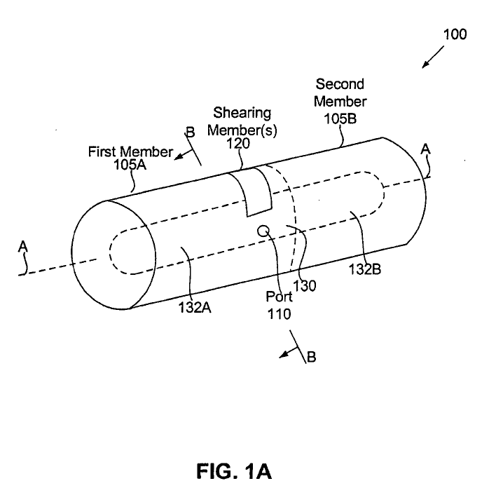

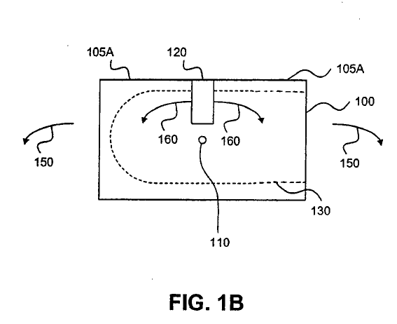

FIG. 1A is a diagram of a kinetic shear vacuum mixer 100 according to an embodiment of the present invention. FIG. 1B is a cross-sectional side diagrammatic view of kinetic shear vacuum mixer 100 according to an embodiment of the present invention. Kinetic shear vacuum mixer 100 includes a first member 105A and second member 105B. First member 105A has a first inner chamber portion 132A. Second member 105B has a second inner chamber portion 132B. First and second members 105A, 105B can be removably coupled to one another. When coupled, first and second inner chamber portions 132A, 132B form a substantially closed chamber 130 within mixer 100. Mixer 100 can have a generally cylindrical shape with a rounded oval or pill-shaped chamber 130 as shown in FIG. 1A-1B. These shapes are illustrative and not intended to limit the present invention as other shapes may be used. An integral housing can also be used instead of a multi-part housing.

According to a feature of the invention, kinetic shear vacuum mixer 100 includes one or more ports 110 and one or more shearing members 120. The ports may be integral with the shearing members. As shown in FIG. 1A, port(s) 110 can be attached to first member 105A. Port(s) 110 can be used to insert and remove materials to and from chamber 130. A vacuum can also be applied through port(s) 110 to the closed chamber during movement of mixer 100 in a mixing operation. The vacuum pressure allows air or gases released during mixing of materials to be removed, further facilitating faster, more complete mixing and producing a substantially gas-free liquid/solid mixture. This is especially advantageous when mixing fine powders with relatively little liquid and requiring a substantially gas-free mixture as in the formation of a polymer ceramic slip, such as a lead zirconate titanate (PZT) polymer slip.

In an example shown in FIGS. 1A and 1B and not intended to limit the invention, port 110 is coupled to first member 105A at a side location of chamber 130. In an example where mixer 100 is moved back and forth along an arcuate path 150 during mixing as shown in FIG. 1B, the material in chamber 130 generally moves in area 160. In this case, port 110 is located at a side location below area 160 so that a vacuum pressure at port 110 will remove air and gases only and will not remove the material being mixed. Any vacuum pressure can be used in this de-gassing including, but not limited to, a pressure less than an ambient atmospheric pressure outside mixer 100. For example, such a vacuum pressure may be a constant pressure of approximately 2 p.s.i.a. (pounds per square inch absolute) which is slightly lower than an ambient pressure of 14.7 p.s.i.a. Port 110 is illustrative. Alternatively, vacuum pressure can be omitted if desired.

Port 110 can be one-way or two-way depending upon a particular application. Multiple one-way or two-way ports can also be used and coupled to either or both of first and second members 105A, 105B.

As shown in FIGS. 1A and 1B, shearing member 120 is coupled to first member 105A and located within area 160 of chamber 130 through which material being mixed travels during movement of mixer 100 in a mixing operation. For instance, as shown in FIG. 1B, when mixer 100 is moved back and forth along arcuate path 150, shearing member 120 is located on a top area so that the material being mixed contacts each shearing member 120. This contact causes shear, turbulence, and air dislodgement within the material and facilitates faster, more complete mixing.

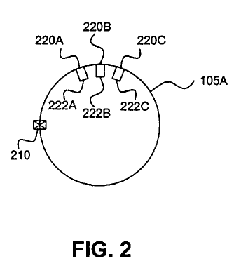

FIG. 2 is a cross-sectional diagrammatic view of a kinetic shear vacuum mixer 100 with a port 210 and three shearing members 220A-C according to an embodiment of the present invention. Shearing members 220A-C are located in a top area and comprises posts having respective face portions 222A-C. In one example, each post 220A-C is a solid member having a cylindrical shape with a flat or rounded face portion 222A-C.

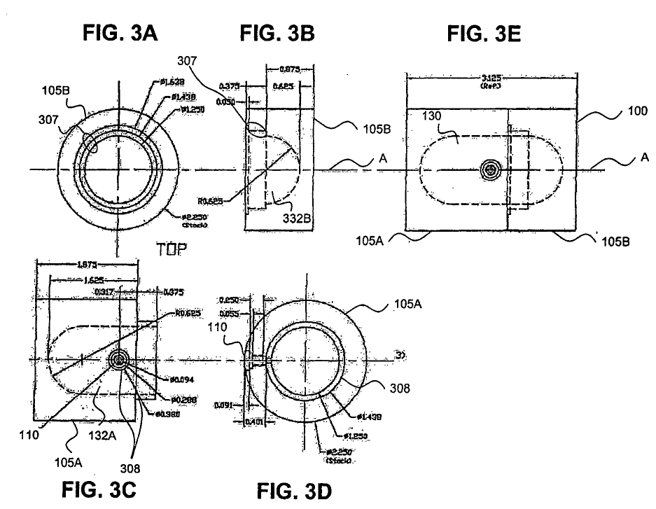

FIGS. 3A to 3E show different sections and views of first and second members 105A, 105B that form chamber 130 of kinetic shear vacuum mixer 100 according to an embodiment of the present invention. As FIGS. 3A to 3E are used herein to describe an example connection between first and second members 105A, 105B, shearing members, such as shearing members 220A-C are not shown. Second member 105B includes concentric ridges 307 formed on one side (see top view in FIG. 3A and side view in FIG. 3B along an axis A). First member 105A includes a ring 308 formed on one side (see side view in FIG. 3C along an axis A and top view in FIG. 3D). When first and second members 105A, 105B are placed adjacent one another as shown in FIG. 3E, ridges 307 and ring 308 interlock to form a leak proof, detachable coupling between second member 105B and first member 105A with a substantially closed chamber 130.

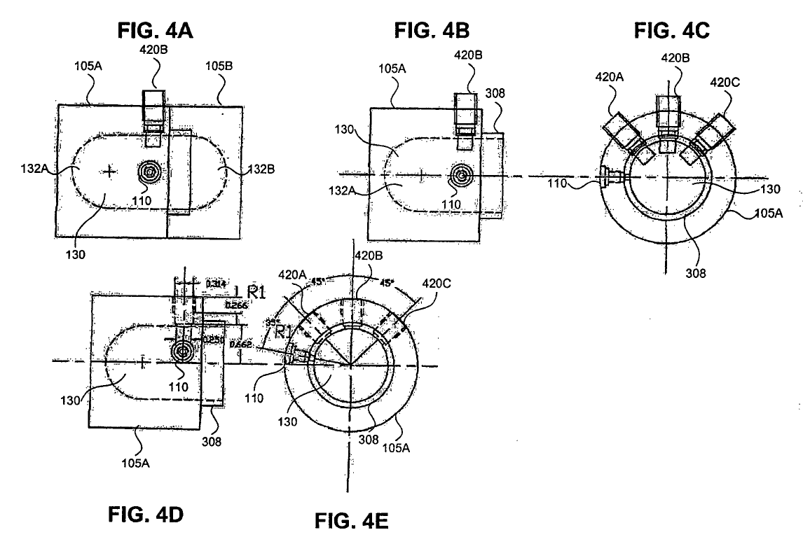

Shearing members, such as shearing members 220A-C, may be fixed so that they always extend into the mixing chamber. Alternatively, the shearing members may be completely removable. Still alternatively, the shearing members may be retractable. FIGS. 4A-4E show different sections and views of kinetic shear vacuum mixer 100 of FIG. 1A with retractable shearing members 420A-C according to a further embodiment of the present invention. Retractable shearing members 420A-C can each move between a retracted position where the shearing member is not located within chamber 130 and a released position where the shearing member is located within chamber 130.

FIGS. 4A-4C show first member 105A with retractable shearing members 420A-C in released positions such that they extend into chamber 130 at first chamber portion 132A. FIG. 4A shows a cross-sectional side view of first member 105A coupled to second member 105B. FIG. 4B shows a cross-sectional side view of first member 105A alone. Retractable shearing member 420B is shown in FIGS. 4A and 4B in a released position that extends into chamber 130 at first chamber portion 132A above a port 110. FIG. 4C is a cross-sectional view that shows retractable shearing members 420A-C in released positions such that they extend into chamber 130 at first chamber portion 132A above port 110. FIG. 4D is a cross-sectional side view of first member 105A with retractable shearing member 420B in a retracted position that does not extend into chamber 130. FIG. 4E is a cross-sectional view of first member 105A with retractable shearing members 420A-C in a retracted position that does not extend into chamber 130. These retractable shearing members 420A-C facilitate automated injection and removal of mixing materials before and after mixing. Retractable shearing members 420A-C can be placed in a retracted state before and after mixing while materials are being inserted or removed from chamber 130. Retractable shearing members 420A-C can be placed in a released state during mixing to impart shearing forces which improves the efficiency of mixing and reduces the time needed to mix materials.

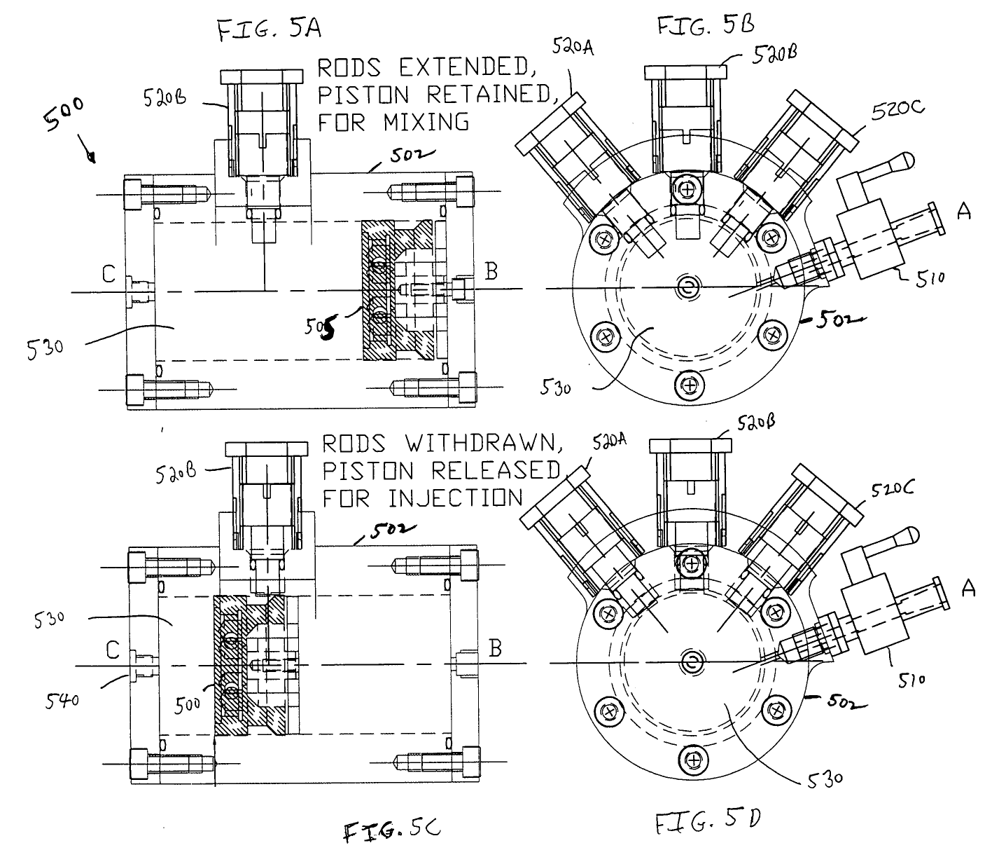

If the shearing members are retractable, a piston may be used to help discharge material after mixing. FIGS. 5A-5D show different sections and views of chambers of a kinetic shear vacuum mixer 500 with retractable shearing members 520A-C, a moveable piston 505, fluid injector/vacuum port 510, and output port 540 according to a further embodiment of the present invention. Mixer 500 has a housing 502 that surrounds a chamber 530 and moveable piston 505. Housing 502 can include an end cover on one side that holds piston 505. Retractable shearing members 520A-C retractably extend within the closed chamber 530. Moveable piston 505 can move between a retained position and a released position within chamber 530. Any number of liquid ingredients or materials can be injected into chamber 530 through port 510. Port 510 can also be used to apply a vacuum as described above.

Each retractable shearing member 520A-C can be extended within the closed chamber when piston 500 is in a retained position during mixing (FIGS. 5A-5B), and retracted from the closed chamber to allow released piston 505 to discharge mixed material from chamber 530 through output port 540 after mixing (FIGS. 5C-5D). This may be accomplished, for example, by applying a pressure through port 510. FIG. 5A is a cross-sectional side view of mixer 500 with retractable shearing member 520B in a released position that extends into chamber 530 and moveable piston 505 in a retracted position for mixing. FIG. 5B is a cross-sectional view of mixer 500 looking toward a surface of piston 505 with retractable shearing members 520A-C in a released position that extends into chamber 530. Injector/vacuum port 510 can be any type and number of ports including but not limited to a tube or syringe for inserting materials to be mixed. FIG. 5C is a cross-sectional side view of mixer 500 with retractable shearing member 520B in a retracted position that does not extend into chamber 530 and moveable piston 505 in a released position after mixing. FIG. 5D is a cross-sectional view of mixer 500 looking toward a surface of piston 505 in a released position with retractable shearing members 520A-C in a retracted position that do not extend into chamber 530. In one example, retractable shearing members 520A-C can be simply screwed out to move them to a retracted position without breaking the vacuum. A retaining screw at port B of housing 502 can be removed and a pressure source connected to port B to move the piston 505 from a retracted position to a released position to collapse the volume in chamber 530, and eventually eject a mixed material (such as a liquid or slip) out of output port 540. Additional fittings, valves, etc. can be used in connection with port 540 to allow the contents of chamber 530 to be injected to any desired cavity, mold, or other container. Piston 505 can be molded of a compressible material, such as silicone rubber, and is wide enough to span chamber 530. Piston 505 can also include a pressure seal to ensure a seal is maintained and avoid gas-blow when a vacuum pressure is applied during mixing.

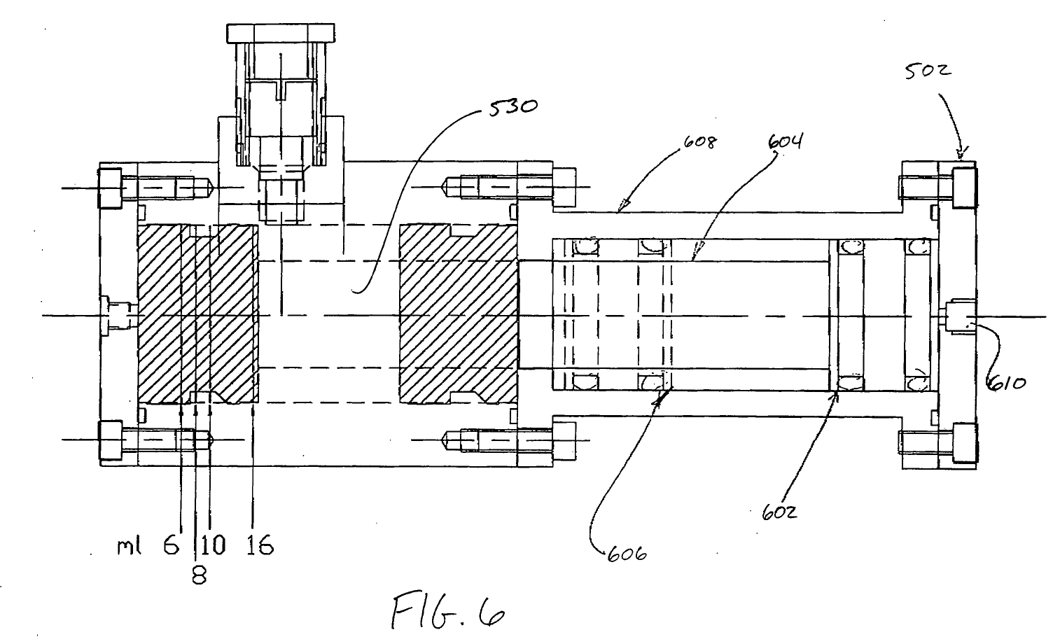

Alternatively, after releasing the piston, cover 502 may be removed and an external piston assembly having a housing 608 installed in its place. This external piston, assembled with the chamber, is shown in FIG. 6. Solid lines at position 602 show a retracted position of external piston 604. Broken lines at position 606 show a released position of piston 604. This piston can be energized by applying pressure to port 610 and exerting a mechanical push on external piston 604. This avoids the possibility of a gas leak by piston 604 into chamber 530, due to a relatively high differential pressure across the piston.

In one application, mixer 500 can be used to mix a fine powder and liquid to form a polymer ceramic slip. The polymer ceramic slip can then be automatically (or manually) ejected from port 540 directly (or indirectly) to a mold for further processing. In this way, mixer 500 allows material to be mixed in a closed chamber with a vacuum pressure and dynamically de-gassed. Resultant mixed material can then be injected or output to a mold or other device without exposure to ambient gas. This avoids possible entrainment and contaminants, and promotes good quality moldings, free of bubbles and gas-induced porosity.

According to a further embodiment, a method for mixing material is provided. For clarity, the method will be described with reference to mixer 500 but is not necessarily limited to the specific structure of mixers 100, 500. The method includes inserting material to be mixed into a chamber 130, 530 having a shearing member 120, 220, 420, 520; shaking the chamber 130, 530 back and forth along a path 150 such that material repeatedly contacts the shearing member during shaking; and applying a vacuum pressure to the material in the chamber during the shaking.

According to a further feature, the method includes, prior to shaking, the steps of moving a piston 505 within the closed chamber to a retained position, and extending each shearing member 520A-C within the closed chamber when piston 505 is in the retained position. The method can also include after shaking, the steps of moving piston 505 to a released position, and retracting each shearing member 520A-C from the closed chamber when the piston is in the released position.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

1. A kinetic shear mixer for mixing material, comprising:
a first member having a first inner chamber portion;
a second member having a second inner chamber portion, wherein said second member can be removably coupled to said first member such that said first and second inner chamber portions form a substantially closed chamber; and
a shearing member coupled to at least one of said first and second members such that said shearing member is located within an area of the closed chamber through which material being mixed travels during movement of the mixer in a mixing operation.

2. The mixer of claim 1, further comprising: at least one port coupled to at least one of said first and second members, whereby a vacuum can be applied to the closed chamber during movement of the mixer in a mixing operation.

3. The mixer of claim 2, wherein the vacuum pressure is less than atmospheric pressure.

4. The mixer of claim 2, wherein said at least one port is coupled to at least one of said first and second members at a side location of the closed chamber below the area through which the material being mixed travels during movement of the mixer in a mixing operation.

5. The mixer of claim 2, wherein prior to the mixing operation, the liquid material to be mixed can be inserted through said at least one port into the closed chamber.

6. The mixer of claim 2, wherein said shearing member comprises a plurality of shearing members, each shearing member comprising a post having a first face portion extending within the closed chamber.

7. The mixer of claim 5, wherein each first face portion of each post is rounded.

8. The mixer of claim 2, wherein said shearing member comprises a plurality of retractable shearing members that can be retractably extended within the closed chamber.

9. The mixer of claim 8, further comprising a moveable piston that can move between a retained position and a released position within the closed chamber, wherein said retractable shearing members can each be extended within the closed chamber when the piston is in the retained position during a mixing operation, and said retractable shearing members can each be retracted from the closed chamber when the piston is in the released position to discharge mixed material from the closed chamber after the mixing operation.

10. The mixer of claim 8, further comprising a moveable piston, external to the closed chamber, that can move between a retained position and a released position, wherein said retractable shearing members can each be extended within the closed chamber when the piston is in the retained position during a mixing operation, and said retractable shearing members can each be retracted from the closed chamber when the piston is in the released position to discharge mixed material from the closed chamber after the mixing operation.

11. A kinetic vacuum shear mixer for mixing material, comprising:
a first member having a first inner chamber portion;
a second member having a second inner chamber portion, wherein said second member can be removably coupled to said first member such that said first and second inner chamber portions form a substantially closed chamber;
a plurality of shearing members coupled to at least one of said first and second members such that each shearing member is located within an area of the closed chamber through which material being mixed travels during movement of the mixer in a mixing operation; and
at least one port coupled to at least one of said first and second members at a location outside of the area of the closed chamber through which material being mixed travels during movement of the mixer in a mixing operation so that a vacuum pressure can be applied through said at least one port to the closed chamber during movement of the mixer in a mixing operation.

12. The mixer of claim 11, wherein the material includes a fine powder and a liquid.

13. A method for mixing material, comprising the steps of:
inserting material to be mixed into a chamber having a shearing member;
shaking the chamber back and forth along a path such that material repeatedly contacts the shearing member during shaking; and
applying a vacuum pressure to the material in the chamber during the shaking.

14. The method of claim 13, further comprising, prior to said shaking, the steps of:
moving a piston within the closed chamber to a retained position; and
extending each shearing member within the closed chamber when the piston is in the retained position.

15. The method of claim 14, further comprising, after said shaking, the steps of:
moving the piston to a released position; and
retracting each shearing member from the closed chamber when the piston is in the released position.

16. The method of claim 13, further comprising, after said shaking, the steps of:
moving an external piston to a released position so as to discharge the material in the closed chamber; and
retracting each shearing member from the closed chamber.

17. The method of claim 13, wherein the vacuum pressure is less than an atmospheric pressure outside the closed chamber.

18. A kinetic shear mixer for mixing material, comprising:
a housing member having an inner chamber portion; and
a shearing member coupled to said housing member such that said shearing member is located within an area of the inner chamber portion through which material being mixed travels during movement of the mixer in a mixing operation.

19. The kinetic shear mixer of claim 18, wherein said housing member comprises:
a first member having a first inner chamber portion; and
a second member having a second inner chamber portion, wherein said second member can be removably coupled to said first member such that said first and second inner chamber portions form a substantially closed chamber.
